(19) United States
(12) Patent Application Publication
(10) Pub. No.: US 2015/0142767 A1
(43) Pub. Date: May 21, 2015

(54) SCORING AUTHORS OF SOCIAL NETWORK CONTENT

(71) Applicants: Yihua Wu, Princeton Junction, NJ (US); Kumar Mayur Thakur, West Orange, NJ (US)

(72) Inventors: Yihua Wu, Princeton Junction, NJ (US); Kumar Mayur Thakur, West Orange, NJ (US)

(73) Assignee: GOOGLE INC., Mountain View, CA (US)

(21) Appl. No.: 12/962,466

(22) Filed: Dec. 7, 2010

(51) Int. Cl. G06F 17/30

(52) U.S. Cl. CPC G06F 17/30867
USPC 707/706; 707/748; 707/E17.009

(57) ABSTRACT

Methods, systems, and apparatus, including computer programs encoded on computer storage media, for scoring authors of social network content. One method includes obtaining a directed interaction graph having nodes representing users and directed edges including interaction edges representing interactions with one or more posts, assigning a weight to each interaction edge in the interaction graph, calculating a user score for each of the users from the graph, and providing the user scores to a ranking system that scores posts generated by users relative to other posts generated by other users based, at least in part, on the user scores of the users and the other users.

### BACKGROUND

This specification relates to information used by a search engine to score and rank social network content.

Users of social networks (e.g., Twitter™ or Facebook™) can generate and share posts. In general, a post is content or information generated and uploaded by a user. For example, users can send tweets through a service such as Twitter™ or can make comments through a service such as Facebook™.

Users in a social network can also subscribe to posts from other users. When a subscribing user subscribes to the posts of a particular user, posts by the particular user, including future posts by the particular user, are automatically made available to the subscribing user. The precise mechanism used to subscribe to posts differs from social network to social network. For example, users of Twitter™ subscribe to posts from a given user by “following” the given user.

Users can also interact with the posts of other users. For example, users can reply to posts or forward the posts to other users. The precise type of interactions depends on the social network. For example, on Twitter™, users reply to posts using “@reply,” and forward messages by “re-tweeting” them.

### SUMMARY

Posts generated by users of social networks can provide useful information and insight on both ongoing and past events. Therefore, a search engine can index publically accessible posts generated by users of social networks and provide search results corresponding to the posts in response to user queries.

To assist a search engine in ranking public posts generated by users of social networks, a quality score for each user who generates posts is obtained and provided to a search engine. The quality score for each user can be determined from (1) the number and type of public interactions that other users in the social network have with posts by the user and (2) the number of public subscriptions to posts generated by each user.

In general, one innovative aspect of the subject matter described in this specification can be embodied in methods that include the actions of obtaining a directed interaction graph, the graph including (i) a plurality of nodes, wherein each node represents a respective user in a social network, and (ii) a plurality of directed edges, wherein the plurality of directed edges includes interaction edges, wherein each interaction edge from a respective first node representing a respective first user to a respective second node representing a respective second user represents one or more interactions of the respective first user with one or more posts generated by the respective second user, and wherein each interaction has a respective type that is one of a predefined plurality of interaction types; determining a weight for each interaction edge in the interaction graph, wherein the weight of each interaction edge from a respective first node to a respective second node is determined at least in part from (i) a respective scoring factor associated with the type of each of the one or more interactions represented by the edge, and (ii) a number of the interactions of each type, wherein each type in the predefined plurality of interaction types has a different scoring factor; calculating a user score for each of the users represented by a node in the graph, wherein the user score for a particular user is determined at least in part from a respective score of each of one or more users represented by a node in the graph with an interaction edge to a node representing the particular user and the weight of each interaction edge to the node representing the particular user; and providing the user scores to a ranking system that scores posts generated by users represented by nodes in the graph relative to other posts generated by other users represented by nodes in the graph based, at least in part, on the user scores of the users and the other users. Other embodiments of this aspect include corresponding systems, apparatus, and computer programs products recorded on computer storage devices, each configured to perform the operations of the methods.

These and other embodiments can each optionally include one or more of the following features. A first interaction edge from a first node representing a first user to a second node representing a second user further represents a subscription by the first user to posts generated by the second user. The weight of the first interaction edge is further determined at least in part from a subscription scoring factor. The plurality of directed edges further includes one or more subscription edges, wherein a subscription edge from a first node representing a first user to a second node representing a second user represents a subscription by the first user to posts generated by the second user and does not represent any interactions by the first user with posts generated by the second user. The actions further comprise determining a respective weight for each subscription edge in the graph, wherein the weight of each subscription edge is determined at least in part from a subscription scoring factor. The subscription scoring factor is less than the scoring factor for any type of interaction in the plurality of interaction types. The user score for a particular user is further determined at least in part from a respective score of each of one or more users each represented by a node in the graph with a subscription edge to a node representing the particular user and the weight of each subscription edge to the node representing the particular user. The weight of each interaction edge between each respective first node and respective second node is further derived from a respective age of each interaction represented by the edge.

The directed interaction graph includes no more than one edge from each node in the graph to each other node in the graph, and at least one interaction edge in the directed interaction graph represents interactions of multiple types. Assigning a weight to each interaction edge in the interaction graph comprises (i) determining a respective value for each type of interaction represented by the edge, (ii) weighting the respective value for each type of interaction by the scoring factor for the type of interaction, and (iii) calculating a weighted sum of the respective values. Each interaction edge in the directed interaction graph represents interactions of a single type, and wherein, for at least one pair of nodes, the directed interaction graph includes multiple interaction edges from one node in the pair to the other node in the pair. Assigning a weight to an interaction edge in the interaction graph comprises deriving a value from the number of interactions of the type of interaction represented by the edge and weighting the value by the scoring factor for the type of interaction represented by the edge. The predefined plurality of interaction types include replying to a post and forwarding a post. The scoring factor for forwarding a post is higher than the scoring factor for replying to a post.

Calculating a user score for each of the users comprises iteratively updating the user scores. Calculating a user score for each of the users comprises: initializing a user score for each node in the graph, wherein the score for each node is one divided by a total number of nodes in the graph; and iteratively updating the user score for each node, wherein the updated user score for each node is derived from a weighted average of scores of nodes with an incoming edge to the node. The score of each node with an incoming edge to the node is weighted by a weight of the incoming edge.

Particular embodiments of the subject matter described in this specification can be implemented so as to realize one or more of the following advantages. Authors of social network content can be scored. User posts can be scored. The quality of a user's post can be inferred from the interactions other users had with previous posts generated by the user or subscriptions other users have to the user's posts. Other content authored or shared by a user, for example, pictures or shared links to web documents, can be scored based in part on the user's score.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example search system.

FIG. 2A illustrates an example directed interaction graph.

FIG. 2B illustrates another example directed interaction graph.

FIG. 3 is a flow diagram of an example method for generating user scores for users of a social network and providing the user scores to a ranking engine.

Like reference numbers and designations in the various drawings indicate like elements.

### DETAILED DESCRIPTION

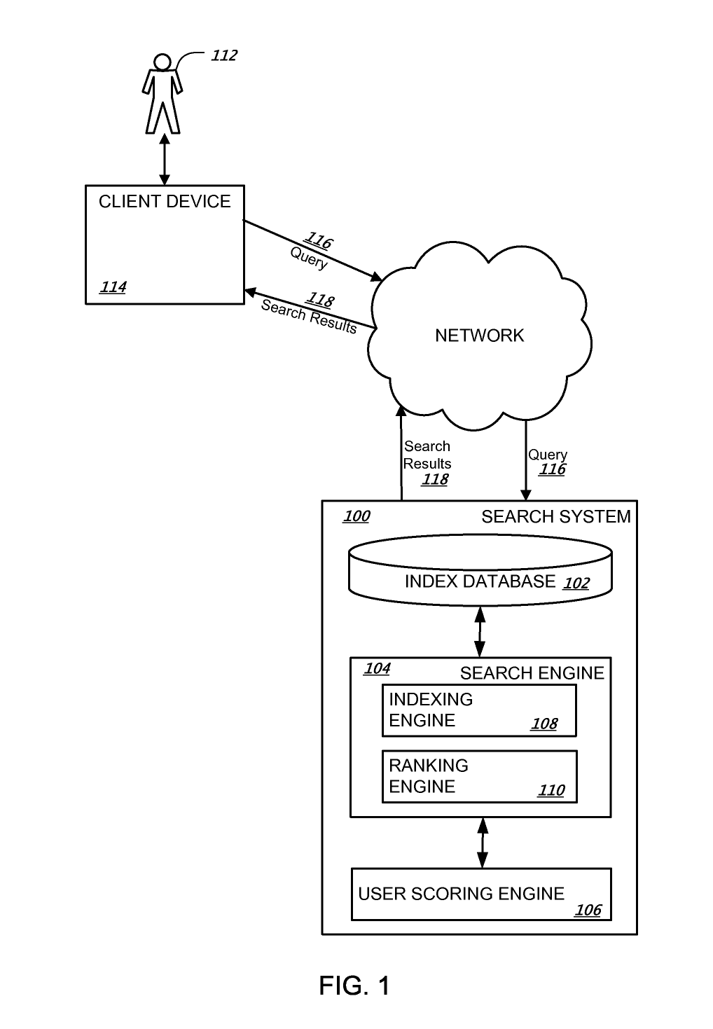

FIG. 1 illustrates an example search system 100 for providing search results relevant to submitted queries as can be implemented in an internet, an intranet, or another client and server environment. The search system 100 can be implemented as, for example, computer programs running on one or more computers in one or more locations that are coupled to each other through a network.

The search system 100 includes an index database 102, a search engine 104, and a user scoring engine 106. The index database 102 stores index data for resources. Example resources include web pages, images, news articles, and social network posts.

The search engine 104 is made up of an indexing engine 108 and a ranking engine 110. The indexing engine 108 indexes resources and stores index information in the index database 102. The ranking engine 110 ranks resources in response to user queries. The ranking engine 110 ranks the resources using conventional techniques. The ranking engine 110 also ranks the resources using a user score for the user who generated each post included in the resources being ranked. The user score can be used by the ranking engine, for example, to determine the quality of a post based on the user score of the user who generated the post. Alternatively or additionally the user score can be used by the ranking engine to generate other scores for resources including, for example, how responsive a post is to a given query. The user score for the user who generated a post can be generated by the user scoring engine 106.

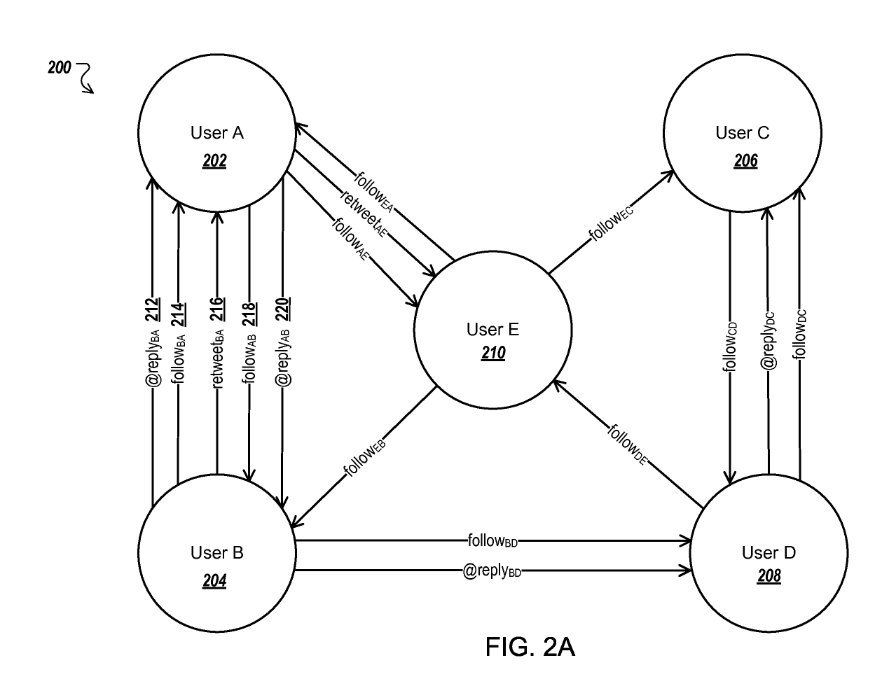

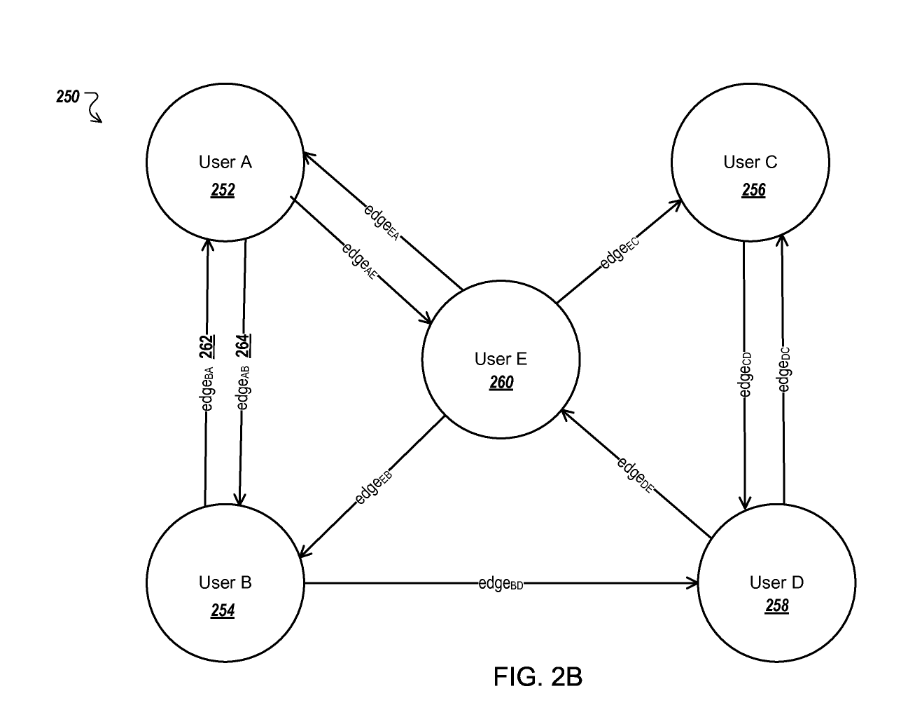

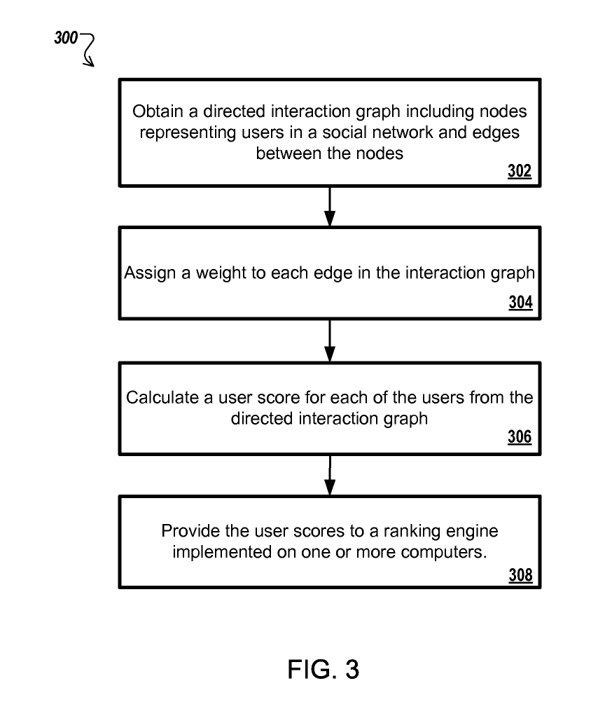

The user scoring engine 106 generates a user score for each user who generated a post indexed by the index engine. The user score is an indicator of the quality of the posts generated by the user. The user score is generated using an interaction graph that represents public interactions that users of a social network have with posts generated by other users of the social network and optionally public subscriptions of users to posts generated by other users. For example, the interaction graph can have nodes representing users and edges representing interactions and subscriptions. Example interaction graphs are described in more detail below with reference to FIGS. 2A and 2B. An example method for generating the user score is described in more detail below, with reference to FIG. 3.

In some implementations, the user scoring engine 106 periodically generates user scores. These scores are then stored and provided by the user scoring engine 106 to the ranking engine 110 as needed. In other implementations, the user scoring engine 106 generates user scores on the fly, as needed.

A user 112 generally interacts with the search system 100 through a user device 114. For example, the user device 114 can be a computer coupled to the search system 100 through a local area network (LAN) or wide area network (WAN), e.g., the Internet. In some implementations, the search system 100 and the user device 114 are implemented on one machine. For example, a user can install a desktop search application on the user device 114.

The user 112 submits a query 116 to the search engine 104 within the search system 100. When the user 112 submits a query 116, the query 116 is transmitted through a network to the search system 100. The search engine 104 identifies and ranks resources that match the query 116. The search system then transmits search results 118 corresponding to the resources through the network to the user device 114 for presentation to the user 112, e.g., in a search results web page to be displayed in a web browser running on the user device 114.

FIG. 2A illustrates an example directed interaction graph 200. The directed interaction graph 200 is used by the user scoring engine 106 described above with reference to FIG. 1 to generate scores for users who generate posts in a social network. For illustrative purposes, the directed interaction graph 200 represents public interactions and subscriptions to posts generated in a social network that uses the conventions of Twitter™. However, corresponding graphs for social networks that use other conventions can also be generated.

Each node of the directed interaction graph 200 represents a user in the social network. For example, node 202 represents user A, node 204 represents user B, node 206 represents user C, node 208 represents user D, and node 210 represents user E.

At least some of the users in the social network generate posts that are viewable to the general public. For example, these users can send tweets through a service such as Twitter™. At least some of the users in the social network publicly subscribe to and interact with posts of other users. For example, some users “follow” other users by subscribing to their posts. Users can also interact with the posts of other users. For example, users can reply to posts using “@reply” or forward the posts to other users by “re-tweeting” the posts.

Each edge from one node in the directed interaction graph 200 to another node in the directed interaction graph 200 represents one user's public interactions of a particular type with posts generated by another user, or one user's public subscription to posts generated by another user. For example, there are three edges from the node 204 representing user B to the node 202 representing user A: @replyBA 212, followBA 214, and retweetBA 216. The @replyBA edge 212 indicates that user B replied to one or more posts generated by user A. The followBA edge 214 indicates that user B follows, or subscribes to, posts from user A. The retweetBA edge 216 indicates that user B re-tweeted, or forwarded, one or more posts generated by user A.

Similarly, there are two edges from the node 202 representing user A to the node 204 representing user B: followAB 218 and @replyAB 220. The followAB edge 218 indicates that user A follows, or subscribes to, posts from user B. The @replyAB edge 220 indicates that user A has replied to one or more posts generated by user B.

Each edge of the graph has an associated weight. The weight is determined from the type of the interaction or subscription that the edge represents and the number of times the subscription or interaction occurred. Each type of interaction or subscription has a different scoring factor that is used in calculating the weights of the edges. The scoring factor can be selected based on the information about quality that each type of interaction or subscription indicates. In some implementations, the weight is further determined from the age of each interaction or subscription, e.g., how long ago in the past each interaction or subscription occurred. For example, older interactions or subscriptions can be weighted less than newer interactions or subscriptions are weighted.

Consider an example where the possible interactions and subscriptions are (1) forward, (2) reply, and (3) subscribe. Subscribing to a user's posts is a passive statement of quality. The fact that a user subscribes to another user's posts does not give a strong indication that the subscribing user reads the posts or thinks the posts are interesting or useful. In contrast, both replying to and forwarding a post require an affirmative step to respond to a particular post. Thus, a reply or a forward is a stronger indication that the replying or retweeting user found the post interesting or useful, and the scoring factor for reply and forward interactions could accordingly be higher than the scoring factor for follow edges.

Continuing the example, replying to a post indicates that the replying user thought the post was worthy of comment, but does not necessarily indicate that the user thought it was worthy of passing on to others. Forwarding a post does indicate that the forwarding user thought the post was good enough, or at least interesting enough, to share with others. Therefore, the scoring factor for forward interactions could accordingly be higher than the scoring factor for reply interactions.

The weight for each edge can be calculated according to a formula that accounts for the type of interaction or subscription represented by the edge and the number of interactions of that type. For example, the weight for an edge from node a to node b that represents interactions or subscriptions of type i can be calculated according to the following formula:

edge weight_{a,b,i}=wᵢƒ(n_{a,b,i})

where wᵢ is the scoring factor for interaction or subscription type i, n_{a,b,i} is the number of interactions or subscriptions of type i that are represented by the edge from node a to node b, and ƒ( ) is a function. For example, ƒ( ) can return n_{a,b,i}. Alternatively, ƒ( ) can return a value calculated based on n_{a,b,i}, for example, log(n_{a,b,i}) or another value based on n_{a,b,i}.

In implementations where the weight for each edge is further determined from the age of the interactions or subscriptions, the weight for an edge from node a to node b that represents interactions or subscriptions of type i can be calculated according to the following formula:

edgeweight_{a,b,i}=wᵢƒ(n_{a,b,i},t_{abi1}, . . . ,t_{abij})

where wᵢ is the scoring factor for interactions or subscriptions of type i, n_{a,b,i} is the number of interactions or subscriptions of type i that are represented by the edge from node a to node b, t_{abi1} . . . t_{abij} are the ages of each interaction or subscription of type i that is represented from the edge from node a to node b,j is equal to n_{a,b,i}, and ƒ( ) is a function that determines a value based on the number of interactions or subscriptions and the age of each interaction or subscription. For example, ƒ( ) can return a weighted count of the interactions or subscriptions, where each interaction or subscription is weighted by a weight derived from its age. For example, the age can be one divided by the number of days, or one divided by the log of the number of days, since the interaction or subscription occurred. As another example, ƒ( ) can return a value derived from the weighted count, for example, the log of the weighted count or a value derived according to a different function of the weighted count.

FIG. 2B illustrates another example directed interaction graph 250. Directed interaction graph 250 represents the same social network represented by the example directed interaction graph 200 described above with reference to FIG. 2A. However, rather than having separate edges for each type of interaction or subscription, the directed interaction graph 250 includes a single edge for any interactions or subscriptions by one user with and to posts generated by of another user. For example, there is one edge from the node for user B 254 to the node for user A 256: edge BA 262. This edge represents the interactions and subscription shown by three separate edges in the interaction graph 200: @replyBA (212), followBA (214), and retweetBA (216). Similarly, there is one edge from the node for user A 252 to the node for user B 254: edgeAB 264. This edge represents the interactions and subscription shown by two separate edges in the interaction graph 200: followAB (218) and @replyAB (220).

In some implementations, each edge of the graph has an associated weight. The weight of each edge is determined from the type of interactions or subscriptions represented by the edge and the number of interactions or subscriptions of each type. In some implementations, the weight is further determined from the age of each interaction or subscription.

For example, in some implementations, the weight can be calculated according to the following formula:

$${edgeweight}_{a , b , i} = {\sum }_{i ∈ I} {w}_{i} f ( {n}_{i} )$$

where I is the set of possible interaction and subscription types, wᵢ is the scoring factor for interaction or subscription type i, nᵢ is the number of interactions or subscriptions of type i that are represented by the edge, and ƒ( ) is a function. For example, ƒ( ) can return nᵢ. Alternatively, ƒ( ) can return a value calculated based on nᵢ, for example, log(nᵢ) or another value based on nᵢ.

In implementations where the weight for each edge is further determined from the age of the interactions or subscriptions, the weight for an edge from node a to node b that represents interactions or subscriptions of type i can be calculated according to the following formula:

$${edgeweight}_{a , b , i} = {\sum }_{i ∈ I} {w}_{i} f ( {n}_{a , b , i} , {t}_{abi 1} , … , {t}_{abij} )$$

where wᵢ is the scoring factor for type i, n_{a,b,i} is the number of interactions or subscriptions of interaction or subscription type i that are represented by the edge from node a to node b, t_{abi1} . . . t_{abij} are the ages of each interaction or subscription of type i that is represented from the edge from node a to node b, j is equal to n_{a,b,i}, and ƒ( ) is a function that determines a value based on the number of interactions or subscriptions and the age of each interaction or subscription. For example, ƒ( ) can return a weighted count of the interactions or subscription, where each interaction or subscription is weighted by a weight derived from its age. The age can be, for example, one divided by the number of days, or one divided by the log of the number of days, since the interaction or subscription occurred. As another example, ƒ( ) can return a value derived from the weighted count, for example, the log of the weighted count or a value derived according to another function of the weighted count.

While FIGS. 2A and 2B describe two example interaction graphs, other interaction graphs can also be used. For example, an interaction graph that includes a separate edge for each individual interaction of a user with posts by another user or each individual subscription by a user to posts generated by another user can be used instead of the graphs described above. Each edge can be weighted based on the scoring factor for the type of interaction and optionally the age of the interaction. Also, in some implementations the interaction graph just includes edges representing interactions (and not subscriptions), or just includes edges representing subscriptions (and not interactions).

FIG. 3 is a flow diagram of an example method 300 for generating user scores for users of a social network and providing the user scores to a ranking engine. For convenience, the method 300 is described with reference to a system of one or more computers that performs the method. The system can be, for example, the search system 100 described above with reference to FIG. 1.

The system obtains a directed interaction graph including nodes representing users in a social network and edges between the nodes (302). Each edge from a node representing a first user to a node representing a second user represents one or more public interactions of the respective first user with one or more posts authored by the second user. The edges can also represent subscriptions by users to posts of other users, as described above with reference to FIGS. 2A and 2B. The directed interaction graph can be represented by data identifying the nodes and edges of the graph, and the weights for each edge. Conventional representations of graphs can be used. Example interaction graphs are described in more detail above with reference to FIGS. 2A and 2B.

In some implementations, the graph has a node for each user in the social network. In other implementations, the graph only includes nodes for users that satisfy one or more predetermined criterion. For example, the graph can only include nodes for users that generate more than a threshold number of posts, generate posts that are interacted with by more than a threshold number of users, generate posts that are subscribed to by more than a threshold number of users, interact with more than a threshold number of posts, or subscribe to posts generated by more than a threshold number of users. In some implementations, the graph has an edge from a node representing a first user to a node representing a second user whenever there has been at least one interaction or subscription by the first user with or to one or more posts of the second user. In other implementations, the graph only includes an edge from a node representing the first user to a node representing the second user when there has been at least a threshold number of subscriptions or interactions by the first user to or with posts generated by the second user, or when the weight of an edge is greater than a pre-determined threshold.

In some implementations, the system obtains the graph from another system. In some implementations, the system generates the graph itself. For example, the system can obtain publicly available data indicating which users of a social network have subscribed to posts from which other users of the social network. The system can also obtain publicly available data on user interactions with posts generated by other users in the social network. For example, if the social network is Twitter, the system can analyze a stream of publicly viewable posts and identify posts tagged as being retweets (e.g., with an “RT” tag) or @replies (e.g., with an @username tag), and use this data to identify the type and number of interactions of users with posts of other users. Similar analyses can be made for other social networks based on the conventions used by the other social networks. The system can then generate the graph based on this obtained data.

The system assigns a weight to each edge in the interaction graph (304). The weight of each edge is determined from at least a scoring factor for each type of interaction associated with the edge and the number of interactions of that type. In some implementations, the weight of the edge is further determined from any subscriptions associated with the edge and the number of subscriptions. In some implementations, the weight of each edge is further determined from the age of each interaction or subscription. The weights are determined, for example, as described above with reference to FIGS. 2A and 2B.

The system calculates a user score for each of the users from the directed interaction graph (306). The user score for a given user is derived from user scores of users represented by nodes with edges to a node representing the given user and the weights of the edges. Various conventional methods that calculate scores based on nodes and edges in a graph can be used. For example, in some implementations, the system uses methods like that described in Lawrence Page, Sergey Brin, Rajeev Motwani, and Terry Winograd, “The Page Rank Citation Ranking, Bringing Order to the Web,” Jan. 29, 1998.

For example, the system can calculate the user scores as follows. First, the system determines an initial score for each node in the graph. For example, each node can be given a score of one divided by the total number of nodes in the graph. The system then iteratively updates the score of each given node in the graph to reflect the scores of the nodes with directed edges that point to the given node. The update replaces the score of the given node with the weighted average of the scores of the nodes with edges that point to the given node. The weight for each score is the weight of the edge between the node and the given node. In some implementations, the updated score also reflects a dampening, or reset, factor.

The system continues iteratively updating the scores of the nodes until a threshold condition is satisfied, for example, until a threshold number of iterations are performed or until the scores of the nodes change by less than a threshold amount.

Other link analysis methods can also be used to determine the scores for the nodes. For example, if query-specific scores are being calculated, the system can use a hubs and authorities method.

The system provides the user scores to a ranking engine implemented on one or more computers (308). The ranking engine scores posts authored by users relative to posts authored by other users based at least in part on the user scores for the users and the other users. For example, the ranking engine can be the ranking engine 110 described above with reference to FIG. 1.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions encoded on a computer storage medium for execution by, or to control the operation of, data processing apparatus. Alternatively or in addition, the program instructions can be encoded on a propagated signal that is an artificially generated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
obtaining publicly available data indicating posts in a social network;
analyzing the publicly available data to classify a first set of the posts as replies to posts and to classify a second set of the posts as re-postings of posts;
generating a directed interaction graph based on the first set of the posts and the second set of the posts, the graph including (i) a plurality of nodes, wherein each node represents a respective user in the social network, and (ii) a plurality of directed edges, wherein the plurality of directed edges includes interaction edges, wherein each interaction edge from a respective first node representing a respective first user to a respective second node representing a respective second user represents one or more interactions of the respective first user with one or more posts generated by the respective second user, and wherein each interaction has a respective type that is one of a predefined plurality of interaction types, the directed interaction graph comprising interaction edges representing replies to posts corresponding to posts in the first set and interaction edges representing re-postings of posts corresponding to posts in the second set;
determining a weight for each interaction edge in the interaction graph, wherein the weight of each interaction edge from a respective first node to a respective second node is determined at least in part from (i) a respective scoring factor associated with the type of each of the one or more interactions represented by the edge, and (ii) a number of the interactions of each type, wherein each type in the predefined plurality of interaction types has a different scoring factor;
calculating a user score for each of the users represented by a node in the graph, wherein the user score for a particular user is determined at least in part from a respective score of each of one or more users represented by a node in the graph with an interaction edge to a node representing the particular user and the weight of each interaction edge to the node representing the particular user; and
providing the user scores to a ranking system that scores posts generated by users represented by nodes in the graph relative to other posts generated by other users represented by nodes in the graph based, at least in part, on the user scores of the users and the other users.

2. The method of claim 1, wherein a first interaction edge from a first node representing a first user to a second node representing a second user further represents a subscription by the first user to posts generated by the second user.

3. The method of claim 2, wherein the weight of the first interaction edge is further determined at least in part from a subscription scoring factor.

4. The method of claim 1, wherein the plurality of directed edges further includes one or more subscription edges, wherein a subscription edge from a first node representing a first user to a second node representing a second user represents a subscription by the first user to posts generated by the second user and does not represent any interactions by the first user with posts generated by the second user.

5. The method of claim 4, further comprising determining a respective weight for each subscription edge in the graph, wherein the weight of each subscription edge is determined at least in part from a subscription scoring factor.

6. The method of claim 5, wherein the subscription scoring factor is less than the scoring factor for any type of interaction in the plurality of interaction types.

7. The method of claim 5, wherein the user score for a particular user is further determined at least in part from a respective score of each of one or more users each represented by a node in the graph with a subscription edge to a node representing the particular user and the weight of each subscription edge to the node representing the particular user.

8. The method of claim 1, wherein the weight of each interaction edge between each respective first node and respective second node is further derived from a respective age of each interaction represented by the edge.

9. The method of claim 1, wherein the directed interaction graph includes no more than one edge from each node in the graph to each other node in the graph, and wherein at least one interaction edge in the directed interaction graph represents interactions of multiple types.

10. The method of claim 9, wherein assigning a weight to each interaction edge in the interaction graph comprises (i) determining a respective value for each type of interaction represented by the edge, (ii) weighting the respective value for each type of interaction by the scoring factor for the type of interaction, and (iii) calculating a weighted sum of the respective values.

11. The method of claim 1, wherein each interaction edge in the directed interaction graph represents interactions of a single type, and wherein, for at least one pair of nodes, the directed interaction graph includes multiple interaction edges from one node in the pair to the other node in the pair.

12. The method of claim 11, wherein assigning a weight to an interaction edge in the interaction graph comprises deriving a value from the number of interactions of the type of interaction represented by the edge and weighting the value by the scoring factor for the type of interaction represented by the edge.

13. The method of claim 1, wherein the predefined plurality of interaction types include replying to a post and forwarding a post.

14. The method of claim 13, wherein the scoring factor for forwarding a post is higher than the scoring factor for replying to a post.

15. The method of claim 1, wherein calculating a user score for each of the users comprises iteratively updating the user scores.

16. The method of claim 15, wherein calculating a user score for each of the users comprises:
initializing a user score for each node in the graph, wherein the score for each node is one divided by a total number of nodes in the graph; and
iteratively updating the user score for each node, wherein the updated user score for each node is derived from a weighted average of scores of nodes with an incoming edge to the node.

17. The method of claim 16, wherein the score of each node with an incoming edge to the node is weighted by a weight of the incoming edge.

18. A system, comprising:
one or more computers and one or more storage devices storing instructions that when executed by the one or more computers cause the one or more computers to perform operations comprising:
obtaining publicly available data indicating posts in a social network;
analyzing the publicly available data to classify a first set of the posts as replies to posts and to classify a second set of the posts as re-postings of posts;
generating a directed interaction graph based on the first set of the posts and the second set of the posts, the graph including (i) a plurality of nodes, wherein each node represents a respective user in the social network, and (ii) a plurality of directed edges, wherein the plurality of directed edges includes interaction edges, wherein each interaction edge from a respective first node representing a respective first user to a respective second node representing a respective second user represents one or more interactions of the respective first user with one or more posts generated by the respective second user, and wherein each interaction has a respective type that is one of a predefined plurality of interaction types, the directed interaction graph comprising interaction edges representing replies to posts corresponding to posts in the first set and interaction edges representing re-postings of posts corresponding to posts in the second set;
determining a weight for each interaction edge in the interaction graph, wherein the weight of each interaction edge from a respective first node to a respective second node is determined at least in part from (i) a respective scoring factor associated with the type of each of the one or more interactions represented by the edge, and (ii) a number of the interactions of each type, wherein each type in the predefined plurality of interaction types has a different scoring factor;
calculating a user score for each of the users represented by a node in the graph, wherein the user score for a particular user is determined at least in part from a respective score of each of one or more users represented by a node in the graph with an interaction edge to a node representing the particular user and the weight of each interaction edge to the node representing the particular user; and
providing the user scores to a ranking system that scores posts generated by users represented by nodes in the graph relative to other posts generated by other users represented by nodes in the graph based, at least in part, on the user scores of the users and the other users.

19. The system of claim 18, wherein a first interaction edge from a first node representing a first user to a second node representing a second user further represents a subscription by the first user to posts generated by the second user.

20. The system of claim 19, wherein the weight of the first interaction edge is further determined at least in part from a subscription scoring factor.

21. The system of claim 18, wherein the plurality of directed edges further includes one or more subscription edges, wherein a subscription edge from a first node representing a first user to a second node representing a second user represents a subscription by the first user to posts generated by the second user and does not represent any interactions by the first user with posts generated by the second user.

22. The system of claim 21, wherein the operations further comprise determining a respective weight for each subscription edge in the graph, wherein the weight of each subscription edge is determined at least in part from a subscription scoring factor.

23. The system of claim 22, wherein the subscription scoring factor is less than the scoring factor for any type of interaction in the plurality of interaction types.

24. The system of claim 22, wherein the user score for a particular user is further determined at least in part from a respective score of each of one or more users each represented by a node in the graph with a subscription edge to a node representing the particular user and the weight of each subscription edge to the node representing the particular user.

25. The system of claim 18, wherein the weight of each interaction edge between each respective first node and respective second node is further derived from a respective age of each interaction represented by the edge.

26. The system of claim 18, wherein the directed interaction graph includes no more than one edge from each node in the graph to each other node in the graph, and wherein at least one interaction edge in the directed interaction graph represents interactions of multiple types.

27. The system of claim 18, wherein each interaction edge in the directed interaction graph represents interactions of a single type, and wherein, for at least one pair of nodes, the directed interaction graph includes multiple interaction edges from one node in the pair to the other node in the pair.

28. A computer storage medium encoded with a computer program, the program comprising instructions that when executed by data processing apparatus cause the data processing apparatus to perform operations comprising:
obtaining publicly available data indicating posts in a social network;
analyzing the publicly available data to classify a first set of the posts as replies to posts and to classify a second set of the posts as re-postings of posts;
generating a directed interaction graph based on the first set of the posts and the second set of the posts, the graph including (i) a plurality of nodes, wherein each node represents a respective user in the social network, and (ii) a plurality of directed edges, wherein the plurality of directed edges includes interaction edges, wherein each interaction edge from a respective first node representing a respective first user to a respective second node representing a respective second user represents one or more interactions of the respective first user with one or more posts generated by the respective second user, and wherein each interaction has a respective type that is one of a predefined plurality of interaction types, the directed interaction graph comprising interaction edges representing replies to posts corresponding to posts in the first set and interaction edges representing re-postings of posts corresponding to posts in the second set;
determining a weight for each interaction edge in the interaction graph, wherein the weight of each interaction edge from a respective first node to a respective second node is determined at least in part from (i) a respective scoring factor associated with the type of each of the one or more interactions represented by the edge, and (ii) a number of the interactions of each type, wherein each type in the predefined plurality of interaction types has a different scoring factor;
calculating a user score for each of the users represented by a node in the graph, wherein the user score for a particular user is determined at least in part from a respective score of each of one or more users represented by a node in the graph with an interaction edge to a node representing the particular user and the weight of each interaction edge to the node representing the particular user; and
providing the user scores to a ranking system that scores posts generated by users represented by nodes in the graph relative to other posts generated by other users represented by nodes in the graph based, at least in part, on the user scores of the users and the other users.

29. The method of claim 1, wherein determining a weight for each interaction edge in the interaction graph comprises:
for one or more of the interaction edges, wherein each of the one or more interaction edges extends from a respective first node a to a respective second node b and represents interactions or subscriptions of type i, calculating a weight according to the following formula:
edge weight_{a,b,i}=wᵢƒ(n_{a,b,i}),
where wᵢ is the scoring factor for interaction or subscription type i, n_{a,b,i} is the number of interactions or subscriptions of type i that are represented by the edge from node a to node b, and ƒ( ) is a function.

30. The method of claim 1, wherein determining a weight for each interaction edge in the interaction graph comprises:
for one or more of the interaction edges, wherein each of the one or more interaction edges extends from a respective first node a to a respective second node b and represents interactions or subscriptions of type i, calculating a weight according to the following formula:
edgeweight_{a,b,i}=wᵢƒ(n_{a,b,i},t_{abi1}, . . . t_{abij}),
where wᵢ is the scoring factor for interactions or subscriptions of type i, n_{a,b,i} is the number of interactions or subscriptions of type i that are represented by the edge from node a to node b, t_{abi1} . . . t_{abij} are the respective ages of each interaction or subscription of type i that is represented from the edge from node a to node b,j is equal to n_{a,b,i}, and ƒ( ) is a function that determines a value based on the number of interactions or subscriptions and the age of each interaction or subscription.

31. The method of claim 30, wherein the function ƒ( ) returns a weighted count of the interactions or subscriptions or a value derived from the weighted count, wherein, in the weighted count, each interaction or subscription is weighted by a weight derived from its age.

32. The method of claim 1, wherein the directed interaction graph includes interaction edges each representing the combined interactions by a particular one of the respective first users with multiple posts generated by a particular one of the respective second users,
wherein determining a weight for each interaction edge in the interaction graph comprises:
calculating one or more of the weights for the interaction edges according to the following formula:
$${edgeweight}_{a , b , i} = {\sum }_{i ∈ I} {w}_{i} f ( {n}_{i} ) ,$$
where edgeweight_{a,b,i} is a weight for the interaction edge from node a to node b, I is the set of possible interaction types, wᵢ is the scoring factor for interaction or subscription type i, nᵢ is the number of combined interactions of type i by the particular one of the respective first users represented by node a with the multiple posts generated by the particular one of the respective second users represented by node b, and ƒ( ) is a function.

33. The method of claim 1, wherein the directed interaction graph includes interaction edges each representing for the combined interactions by a particular one of the respective first users with multiple posts generated by a particular one of the respective second users,
wherein determining a weight for each interaction edge in the interaction graph comprises:
calculating one or more of the weights for the interaction edges according to the following formula:
$${edgeweight}_{a , b , i} = {\sum }_{i ∈ I} {w}_{i} f ( {n}_{a , b , i} , {t}_{abi 1} , … , {t}_{abij} ) ,$$
where edgeweight_{a,b,i} is a weight for the interaction edge from node a to node b, wᵢ is the scoring factor for type i, n_{a,b,i} is the number of combined interactions of interaction type i that are represented by the interaction edge from node a to node b, t_{abi1} . . . t_{abij} are the ages of each interaction of type i by the particular one of the respective first users represented by node a with the multiple posts generated by the particular one of the respective second users represented by node b, j is equal to n_{a,b,i}, and ƒ( ) is a function that determines a value based on the number of interactions and the age of each interaction.

34. The method of claim 33, wherein the function ƒ( ) returns a weighted count of the interactions or subscriptions a value derived from the weighted count, wherein, in the weighted count, each interaction or subscription is weighted by a weight derived from its age.

35. The method of claim 1, wherein determining the weight for each interaction edge in the interaction graph comprises:
determining one or more weights for the interaction edges based on the first set of the posts and the second set of the posts, wherein weights for interaction edges representing interactions of a reply type are determined based on the posts in the first set of the posts and weights for interaction edges representing interactions of a re-posting or forward type are determined based on posts in the second set of the posts.
